(19) United States
(12) Patent Application Publication
(10) Pub. No.: US 2021/0284201 A1
(43) Pub. Date: Sep. 16, 2021

(54) INFORMATION PROCESSING APPARATUS, INFORMATION PROCESSING METHOD AND PROGRAM

(71) Applicant: TOYOTA JIDOSHA KABUSHIKI KAISHA, Toyota-shi (JP)

(72) Inventors: Takahiro HARADA, Chiryu-shi (JP); Teppei NISHIGUCHI, Nisshin-shi (JP); Kazuki KOMORIYA, Toyota-shi (JP); Tomoaki IHARA, Toyota-shi (JP); Miyu HIGASHIMURA, Toyota-shi (JP); Toshihiro NAKAICHI, Nagoya-shi (JP); Kazunobu OKASAKA, Toyota-shi (JP); Ryo HATTORI, Kariya-shi (JP); Yohei TANIGAWA, Toyota-shi (JP); Ryohei KIMBARA, Toyota-shi (JP); Hiroshi NAKAMURA, Nagoya-shi (JP)

(73) Assignee: TOYOTA JIDOSHA KABUSHIKI KAISHA, Toyota-shi (JP)

(21) Appl. No.: 17/135,208

(22) Filed: Dec. 28, 2020

(30) Foreign Application Priority Data
Mar. 11, 2020 (JP) 2020-042029

(51) Int. Cl. B60W 60/00; G08G 1/00; G01C 21/36; G05D 1/00

(52) U.S. Cl. CPC B60W 60/0024; G08G 1/202; G05D 2201/0212; G05D 1/0022; G05D 1/0027; G01C 21/3605

(57) ABSTRACT

An information processing apparatus manages a vehicle platform capable of being loaded with a plurality of vehicle compartment units, a first vehicle compartment unit configured to transport a passenger and a second vehicle compartment unit configured to transport cargo. The first and second vehicle compartment units are capable of being loaded on the vehicle platform. The information processing apparatus includes a control unit configured to acquire first demand data representing demand associated with transportation of the passenger and second demand data representing demand related to transportation of the cargo in a predetermined period, and determine a combination of one or more first vehicle compartment units and one or more second vehicle compartment units, which are loaded on a predetermined vehicle platform, based on the first demand data and the second demand data.

### CROSS-REFERENCE TO RELATED APPLICATION

This application claims priority to Japanese Patent Application No. 2020-042029 filed on Mar. 11, 2020, incorporated herein by reference in its entirety.

### BACKGROUND

### 1. Technical Field

The present disclosure relates to a technology of providing a service by a vehicle.

### 2. Description of Related Art

Providing services by dispatching self-driving vehicles designed for various purposes has previously been attempted. For example, Japanese Unexamined Patent Application Publication No. 2019-075047 (JP 2019-075047 A) discloses a device that determines a vehicle to be dispatched based on demand for services and a service status of the vehicle, and issues a command to the vehicle to travel.

The vehicle is configured by combining a vehicle platform (chassis) and a cabin module (vehicle compartment), and various demands can be satisfied by replacing the vehicle compartment.

### SUMMARY

According to the disclosure disclosed in JP 2019-075047 A, the vehicle can be used in various ways by replacing the vehicle compartment loaded on the chassis. However, since equipment can only be replaced along with the vehicle compartment, a part of the equipment may not be properly utilized. For example, passengers may be unable to board vehicles for transporting cargo.

The present disclosure is to provide a vehicle capable of simultaneously carrying passengers and cargo.

A first aspect of the present disclosure is an information processing apparatus, which manages a vehicle platform configured to be loaded with a plurality of vehicle compartment units, a first vehicle compartment unit configured to transport a passenger and a second vehicle compartment unit configured to transport cargo. The first and second vehicle compartment units are capable of being loaded on the vehicle platform. In particular, the information processing apparatus includes a control unit configured to acquire first demand data representing demand associated with transportation of the passenger and second demand data representing demand associated with transportation of the cargo in a predetermined period, and determine a combination of one or more first vehicle compartment units and one or more second vehicle compartment units, which are loaded on a predetermined vehicle platform, based on the first demand data and the second demand data.

A second aspect of the present disclosure is an information processing method executed by an information processing apparatus. In particular, the information processing method includes a step of acquiring first demand data representing demand associated with transportation of a passenger and second demand data representing demand associated with transportation of cargo in a predetermined period, and a step of determining a combination of one or more first vehicle compartment units and one or more second vehicle compartment units, which are loaded on a predetermined vehicle platform, based on the first demand data and the second demand data.

Another aspect of the present disclosure is a program causing a computer to execute an information processing method executed by the information processing apparatus, or a non-transitory computer-readable storage medium storing the program.

With the present disclosure, it is possible to provide a vehicle capable of simultaneously carrying passengers and cargo.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram illustrating a transportation system according to an embodiment;

FIG. 2 is a diagram illustrating an appearance of a vehicle according to the embodiment;

FIG. 3A is a diagram illustrating a combination of service units;

FIG. 3B is a diagram illustrating a combination of service units;

FIG. 3C is a diagram illustrating a combination of service units;

FIG. 3D is a diagram illustrating a combination of service units;

FIG. 4 is a diagram illustrating a system configuration of a server device;

FIG. 5A shows an example of vehicle data stored in the server device;

FIG. 5B shows an example of service unit data stored in the server device;

FIG. 6 is a diagram illustrating an example of a transportation schedule of the vehicle;

FIG. 7 is a diagram illustrating system configurations of the vehicle and the service unit;

FIG. 8 is a diagram illustrating an example of demand data acquired by the server device;

FIG. 9 is a flowchart illustrating a process executed by the server device;

FIG. 10 is a flowchart illustrating a process executed by the server device; and

FIG. 11 is a flowchart illustrating a process executed by the vehicle.

### DETAILED DESCRIPTION OF EMBODIMENTS

The information processing apparatus according to the present embodiment is an apparatus that manages a vehicle in which a chassis portion and a body portion can be separated, and also an apparatus that determines a combination of body units (first vehicle compartment unit) for transporting passengers and body units (second vehicle compartment unit) for transporting cargo. It is possible to meet both passengers and cargo demand by combining one or more first vehicle compartment units and one or more second vehicle compartment units, which are loaded on the chassis (hereinafter referred to as a “vehicle platform”).

The vehicle platform may be, for example, a moving vehicle provided with a plurality of wheels and drives. The vehicle platform only has to have a traveling function and does not necessarily have to have a room. The vehicle platform is configured to be able to have a plurality of vehicle compartment units having different functions. It is possible to build a vehicle used for a predetermined purpose by loading a predetermined vehicle compartment unit on the vehicle platform. In addition, the vehicle can be used in other ways by detaching the loaded vehicle compartment unit from the vehicle platform and replacing another vehicle compartment unit. Further, the vehicle platform may also be equipped with multiple vehicle compartment units.

Examples of vehicle compartment units that can be loaded on a vehicle platform include units for transporting passengers (for example, units having seats and an air conditioner) and units for transporting cargo (for example, units for storing containers).

The information processing apparatus according to the present embodiment includes a control unit configured to acquire first demand data representing demand related to transportation of passengers and second demand data representing demand related to transportation of cargo in a predetermined period, and determine a combination of at least one of the first vehicle compartment units and at least one of the second vehicle compartment units, which are loaded on the predetermined vehicle platform, based on the first demand data and the second demand data.

The information processing apparatus selects two or more units according to demand for transporting passengers and demand for transporting cargo, and determines how to combine the units. The first demand data is data representing the demand for transporting passengers. The first data may be, for example, data including boarding points and alighting points of passengers, as well as the number of passengers. Further, the second demand data is data representing the demand for transporting cargo. The second data may be, for example, data including loading points and unloading points of cargo, as well as the number and sizes of pieces of cargo. It is possible to simultaneously transport passengers and cargo with the single vehicle platform by determining the combination of the vehicle compartment units based on the demand data, and loading the vehicle compartment units on the vehicle platform.

Further, the first demand data may include the number of passengers to be transported, and the control unit may be configured to determine the number or sizes of the first vehicle compartment units to be loaded on the vehicle platform in accordance with the number of passengers. According to such a configuration, it is possible to determine the appropriate number or sizes of vehicle compartment units in response to the required passenger transportation capacity.

Further, the second demand data may include an amount of cargo to be transported, and the control unit may be configured to determine the number or sizes of the second vehicle compartment units to be loaded on the vehicle platform according to the amount of cargo. According to such a configuration, it is possible to determine the appropriate number or sizes of vehicle compartment units in response to the required cargo transportation capacity.

Further, the control unit may be configured to periodically acquire information indicating locations of the first vehicle compartment unit and the second vehicle compartment unit. The information may be directly received from the vehicle compartment unit or may be acquired via another device. It is possible to easily schedule vehicle configuration by managing the vehicle compartment units based on the information.

Further, the control unit may be configured to determine a base where at least one of the first vehicle compartment unit and the second vehicle compartment unit, as determined, can be provided. Moreover, the control unit may be configured to determine an operation route of the vehicle platform that passes through the determined base. The vehicle capable of transporting passengers and cargo can be built by loading the vehicle compartment units on the vehicle platform at the base.

Further, the control unit may be configured to determine an operation route of the vehicle platform that passes through a point designated by the first demand data and the second demand data. The points specified by the demand data may include, for example, points where passengers board, points where passengers alight, points where cargo is loaded, and points where cargo is unloaded.

Further, the control unit may be configured to determine a command to cause the vehicle platform to operate along the operation route as determined. Moreover, the command may include a command to load at least one of the first vehicle compartment unit and the second vehicle compartment unit, as determined, on the vehicle platform at the determined base. Additionally, the command may include a command to allow the passengers to board or alight from the vehicle and the cargo to be loaded on or unloaded from the vehicle at the designated point.

Consequently, the command generated by the information processing apparatus may include the command for loading the vehicle compartment unit on the vehicle platform and the command for transporting passengers and cargo.

Hereinafter, embodiments of the present disclosure will be described with reference to the drawings. Configurations of the following embodiments are merely an example, and the present disclosure is not limited to those configurations of the embodiments.

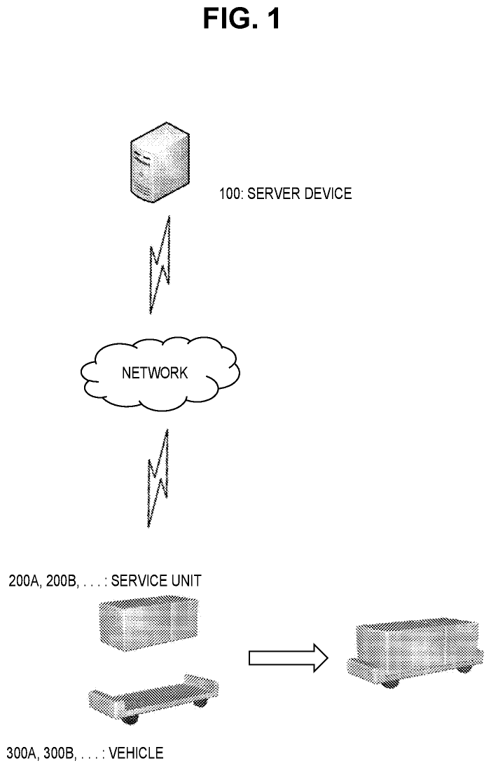

An outline of a transportation system according to an embodiment will be described with reference to FIG. 1. A delivery system according to the present embodiment includes one or more vehicles (300A, 300B, . . . ), each of which autonomously travels on a given command, one or more service units (200A, 200B, . . . ), and a server device 100 that issues commands. Hereinafter, in a case where the plurality of vehicles is collectively referred to without being individually distinguished, they are simply referred to as a vehicle 300. Further, in a case where the plurality of service units is collectively referred to without being individually distinguished, they are simply referred to as a service unit 200.

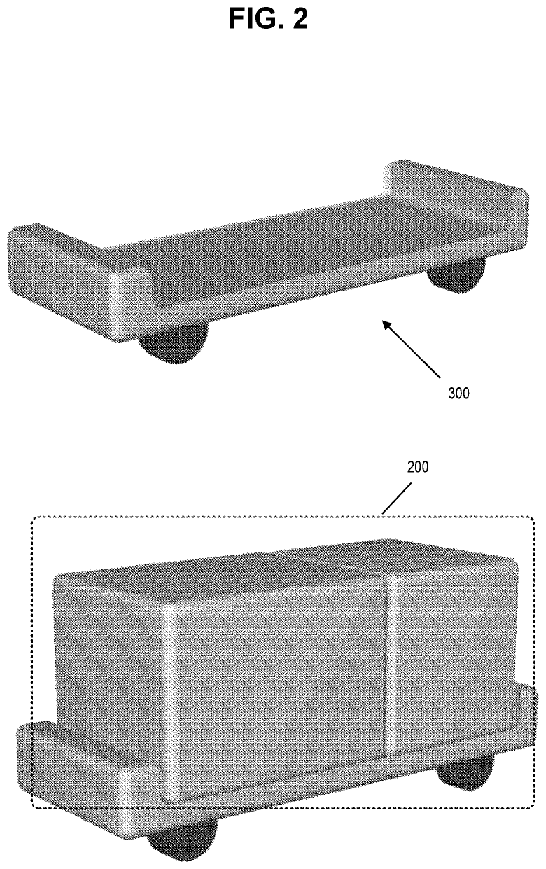

The vehicle 300 is a moving vehicle for carrying passengers or cargo. The vehicle 300 is in a chassis form without a vehicle compartment, and displays a predetermined function by loading the optional service unit 200. FIG. 2 is an external view illustrating an example in which the service unit 200 is loaded on the vehicle 300. In addition, the vehicle 300 does not have to be an unmanned vehicle. For example, security staff may ride the vehicle. Further, the vehicle 300 may not necessarily be a vehicle capable of complete autonomous traveling. For example, it may be a vehicle in which a person drives or assists driving depending on a situation.

The service unit 200 is a unit for transporting passengers or cargo. The transportation system according to the present embodiment transports passengers or cargo using several service units 200 each having a different function. In the present embodiment, two types of service units are used, a unit dedicated to transporting passengers and a unit dedicated to transporting cargo. The former is called a passenger unit and the latter is called a cargo unit. The passenger unit is a unit for allowing a person to board, and includes, for example, seats, tables, air conditioners, and audio & video devices. The cargo unit is a unit for loading cargo, and includes, for example, equipment for fixing containers and boxes, shock absorbers, refrigerators and freezers.

The vehicle 300 can replace the service unit 200 at a predetermined base (hereinafter referred to as a “service base”). The vehicles 300 and the service units 200 that are not in operation can be kept at the service base.

In the example described above, the service unit 200 is loaded on the vehicle 300. However, if the vehicle 300 and the service unit 200 can be coupled by a predetermined mechanism, the service unit 200 is not necessarily placed on the vehicle 300. The mechanism of coupling the vehicle 300 and the service unit 200 is not particularly limited. For example, a locking mechanism may be used for mechanical coupling and separating the vehicle 300 and the service unit 200, or alternatively, an electromagnet may be used. Further, a method of loading or unloading the service unit 200 on or from the vehicle 300 may include, for example, a method of using a dedicated lift, and a method of using a mechanism provided in the vehicle 300 or the service unit 200. The method of loading or unloading the service unit 200 on or from the vehicle 300 is not particularly limited. In the present embodiment, the vehicle 300 has a lift and the optional service unit 200 can autonomously board and alight from the vehicle 300.

The server device 100 is a device that manages services offered by the vehicle 300. As described above, there are several types of the service units 200 for each function, thus it is necessary to select the appropriate type and load it on the vehicle.

For example, in a case where there are passengers intending move between certain points, it is necessary to load the passenger unit on the vehicle 300 which allows all the passengers to board. Further, in a case where there is a plurality of piece of cargo to be moved between certain points, it is necessary to load the cargo unit on the vehicle 300, which is capable of accommodating all the cargo. Moreover, in a case where passengers and cargo are simultaneously transported, it is necessary to determine the capacities of the passenger unit and the cargo unit according to the number of passengers and the amount of cargo. This is because the number of service units that can be loaded on the single vehicle 300 is limited.

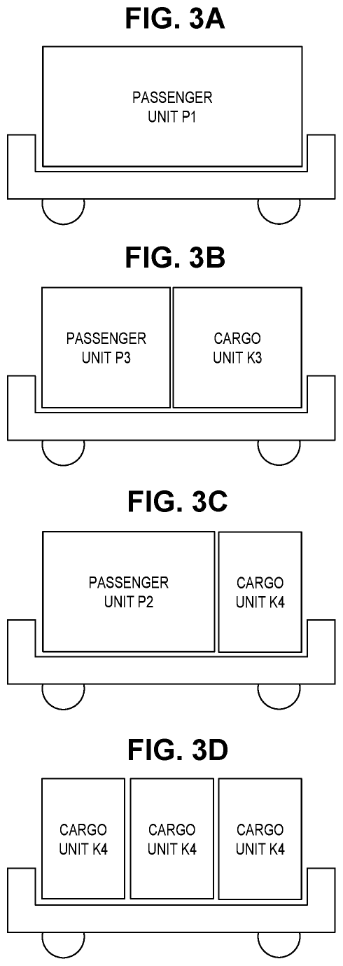

FIGS. 3A to 3D are diagrams illustrating types and numbers of the service units 200 loaded on the vehicle 300. For example, in a case where only passengers have to be transported, only the passenger unit may be loaded on the vehicle as shown in FIG. 3A. Further, in a case where passengers and cargo have to be transported at the same time, both the passenger unit and the cargo unit may be loaded on the vehicle as shown in FIG. 3B. In the configuration of FIG. 3B, in a case where the number of passengers is large and the amount of cargo is small, the capacity of the cargo unit is reduced while the capacity of the passenger unit is increased as shown in FIG. 3C. Accordingly, a plurality of the passenger units or cargo units having different capacities may be prepared and appropriate units may be loaded in response to the demand. Further, in a case where there is no passenger to be transported, only the cargo unit may be loaded as shown in FIG. 3D.

As described above, the server device 100 according to the present embodiment determines the types and numbers of the service units 200 to be loaded on the vehicle 300 according to the demand of transporting passengers and/or cargo. In the transportation system according to the present embodiment, the predetermined service unit 200 is loaded on the vehicle 300 and operated as determined by the server device 100.

In the present embodiment, the server device 100 acquires data relating to the demand for transporting passengers and cargo, and determines a service unit to be loaded on the vehicle 300 and a route along which the vehicle 300 travels in response to the demand. Further, a command for loading the determined service unit and traveling the vehicle with the loaded service unit is generated and transmitted to the vehicle 300. According to such a configuration, it is possible to transport both passengers and cargo with only minimum resources.

The server device 100, the service unit 200, and the vehicle 300 are connected to each other by a network. The network may be, for example, a worldwide public communication network such as Internet or the like, and a WAN (Wide Area Network) or other communication network. The network may include a mobile communication network such as a mobile phone or the like, and a wireless communication network such as Wi-Fi (registered trademark) or the like.

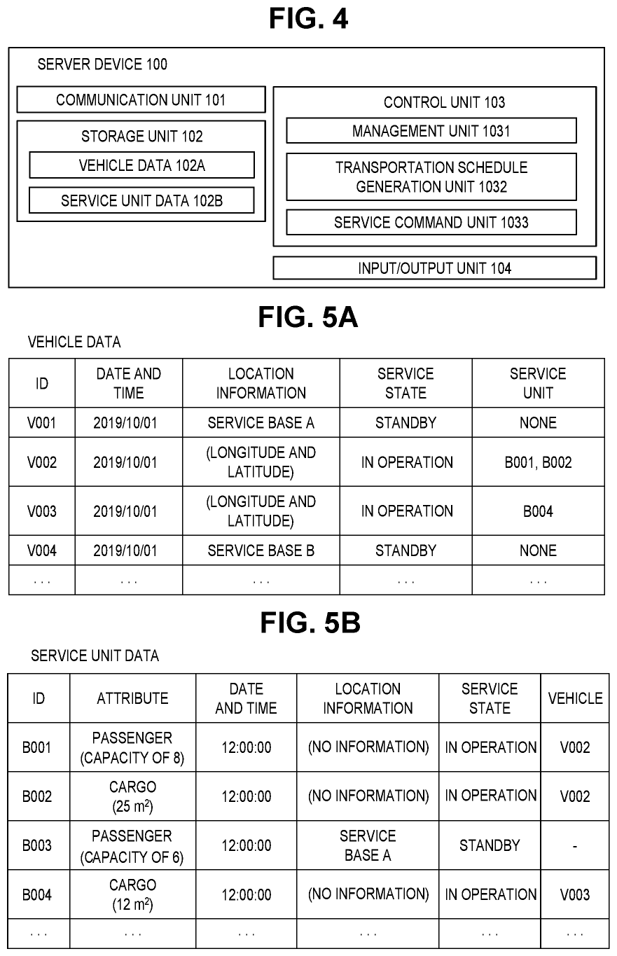

Next, the server device 100 will be described in detail. FIG. 4 is a diagram illustrating a system configuration of the server device 100. The server device 100 is configured to include a communication unit 101, a storage unit 102, a control unit 103, and an input/output unit 104.

The server device 100 is configured by a general computer. In other words, the server device 100 is a computer having a processor such as a CPU or GPU, a main storage device such as a RAM and a ROM, an auxiliary storage device such as an EPROM, a hard disk drive, and a removable medium. The removable medium may be, for example, a USB memory or a disk recording medium such as a CD or a DVD. An operating system (OS), various programs, various tables and the like are stored in the auxiliary storage device. The programs stored therein are loaded into a work area of the main storage device and executed, thus each function that matches a predetermined purpose is implemented as described later. Some or all of the functions may be implemented by a hardware circuit such as ASIC or FPGA. Further, the server device 100 may be configured by a single computer or a combination of computers that cooperate with each other.

The communication unit 101 is a communication interface configured to allow the server device 100 to access the network. The communication unit 101 is configured to include, for example, a network interface board and a wireless communication circuit for wireless communication.

The storage unit 102 is configured to include a main storage device and an auxiliary storage device. The main storage device is a memory in which a program executed by the control unit 103 and data used by the control program are expanded. The auxiliary storage device is a device in which a program executed in the control unit 103 and data used by the control program are stored.

Further, the storage unit 102 stores vehicle data 102A and service unit data 102B. The vehicle data 102A is data for managing the vehicle 300. FIG. 5A shows an example of the vehicle data. The vehicle data is data for describing an identifier of the vehicle 300 managed by the server device 100, as well as the vehicle's location information or state. The vehicle data may include other information. For example, the vehicle data may include information on an owner, a standby point (garage or sales office), a vehicle body size, a loading capacity, a maximum driving range when fully charged, a maximum driving range at present, and a currently executed task of the vehicle 300, and an identifier of the service unit 200 loaded thereon. The vehicle data is periodically updated based on the information transmitted from the vehicle 300.

The service unit data 102B is data for managing the several service units 200. FIG. 5B shows an example of the service unit data. The service unit data is data for describing an identifier of the service unit 200 managed by the server device 100, as well as its location information or state. The service unit data may include other information. For example, the service unit data may include information on an owner, subject to be transported (passenger or cargo), attributes (for example, passenger capacity or loading capacity), and a standby point (garage or sales office), of the service unit 200, as well as information on an identifier of the vehicle 300 loading the service unit 200. The service unit data is periodically updated based on the information transmitted from the service unit 200.

A database for storing those pieces of data is constructed by a database management system (DBMS) program that is executed by the processor and manages the data stored in the storage device. The database used in the present embodiment may be, for example, a relational database.

The control unit 103 is an arithmetic unit dealing with controls executed by the server device 100. The control unit 103 can be implemented by an arithmetic processing device such as a CPU. The control unit 103 is configured to include three functional modules including a management unit 1031, a transportation schedule generation unit 1032, and a service command unit 1033. Each functional module may be implemented by executing a program stored in an auxiliary storage device by the CPU.

The management unit 1031 periodically communicates with the vehicles 300 to collect information on the vehicles 300. The collected information is reflected in the vehicle data 102A. The management unit 1031 also periodically communicates with the service units 200 to collect information on the service units 200. The collected information is reflected in the service unit data 102B.

The transportation schedule generation unit 1032 acquires demand data and generates a schedule for traveling the vehicle 300 (hereinafter referred to as a “transportation schedule”) based on the demand data. The demand data is data indicating demand for transporting passengers and cargo. The transportation schedule generation unit 1032 determines the vehicle 300 which will transport passengers or cargo, and also determines the types and numbers of the service units 200 to be loaded into the vehicle 300 in order to meet the demand. Further, the transportation schedule generation unit 1032 identifies a base at which the required service unit 200 is kept, and generates a route including the base and points where passengers board and alight, and cargo is loaded and unloaded.

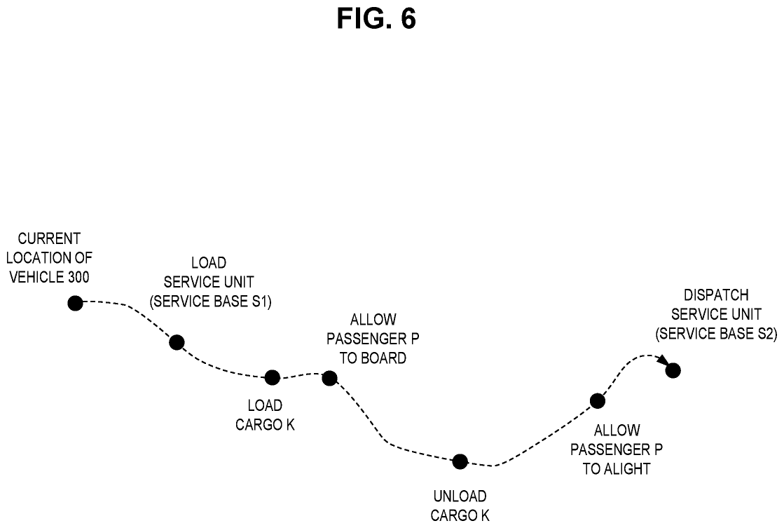

FIG. 6 shows an example of the transportation schedule. In the illustrated example, a transportation schedule is shown in which the vehicle 300 travels to a service base S1, loads the service unit 200 at the service base S1, loads cargo K and allows a passenger P to board, unloads the cargo K and allows the passenger P to alight, and then travels to a service base S2.

The service command unit 1033 generates a command (service command) to be transmitted to the vehicle 300 based on the generated transportation schedule. The service command is a command for executing several tasks for implementing the transportation schedule. In the example shown in FIG. 6, the service command includes commands for executing the following tasks:

(1) task to travel to the service base S1

(2) task to load the predetermined service unit 200 at the service base S1

(3) task to travel to a point where the cargo K is loaded

(4) task to load the cargo K

(5) task to travel to a point where the passenger P boards

(6) task to allow the passenger P to board

(7) task to travel to a point where the cargo K is unloaded

(8) task to unload the cargo K

(9) task to travel to a point where the passenger P alights

(10) task to allow the passenger P to alight

(11) task to travel to the service base S2

(12) task to dispatch the service unit 200

The vehicle 300 travels according to the service command generated by the service command unit 1033.

The input/output unit 104 is an interface that presents the information to a user of the system (typically, a business operator who causes the vehicle to operate) and acquires the information. The input/output unit 104 is configured to include, for example, a display device and a touchscreen.

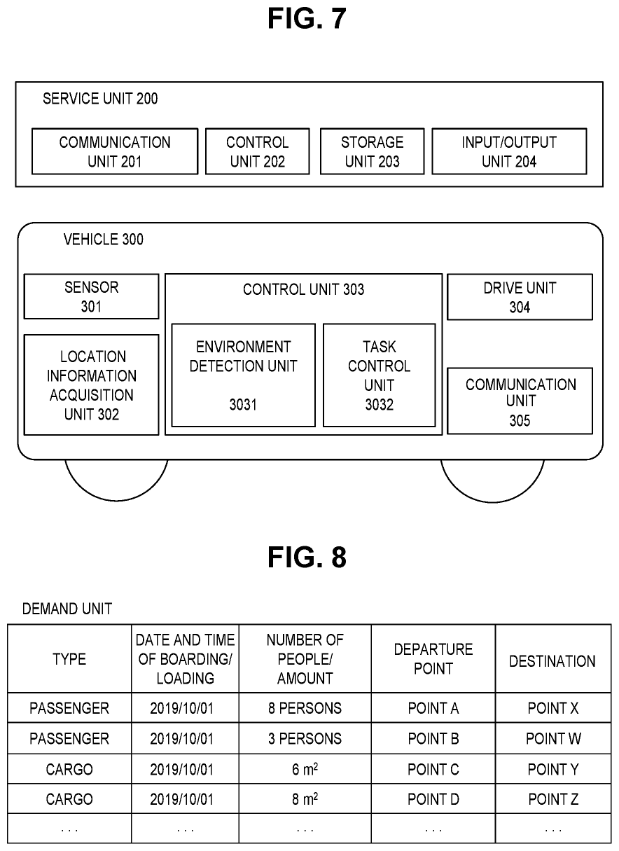

FIG. 7 is a diagram illustrating system configurations of the service unit 200 and the vehicle 300. The service unit 200 is configured to include a communication unit 201, a control unit 202, a storage unit 203, and an input/output unit 204. The service unit 200 operates with electric power supplied from a battery.

The communication unit 201 is a communication interface for communicating with the server device 100 or the vehicle 300 via the network.

The control unit 202 is a computer that controls the operations of the service unit. The control unit 202 may be configured by a microcomputer, for example. The control unit 202 may be implemented by executing a program stored in a storage device (such as ROM) by the CPU. The control unit 202 cooperates with the vehicle 300 (control unit 303) to execute a predetermined task (for example, a task to allow passengers to board or cargo to be loaded).

The storage unit 203 is a unit configured to store information, which is configured by a storage medium such as a RAM, a magnetic disk, a flash memory or the like. The storage unit 203 stores a program executed in the control unit 202 and data used by the control program.

The input/output unit 204 is an interface that inputs/output the information to/from the user. The input/output unit 204 is configured to include, for example, a display device and a touchscreen. In a case where the service unit 200 is the passenger unit, the information may be provided to passengers via the input/output unit 204. Further, in a case where the service unit 200 is the cargo unit, the information may be provided to a user who loads and unloads cargo via the input/output unit 204. Moreover, the input/output unit 204 may be configured to input/output information for authentication of the user.

The vehicle 300 will be described hereinbelow. The vehicle 300 is the vehicle platform traveling according to the service command acquired from the server device 100. In particular, a travel route is generated based on the service command acquired via wireless communication, and the vehicle travels on a road via an appropriate method while sensing the surroundings of the vehicle. Further, the vehicle 300 executes a predetermined task including loading and unloading the service unit 200 on the route.

The vehicle 300 is configured to include a sensor 301, a location information acquisition unit 302, a control unit 303, a drive unit 304, and a communication unit 305. The vehicle 300 operates with electric power supplied from a battery.

The sensor 301 is a unit configured to sense the surroundings of the vehicle, and typically includes a stereo camera, a laser scanner, a LIDAR, a radar, and the like. The information acquired by the sensor 301 is transmitted to the control unit 303. The sensor 301 includes a sensor that enables the vehicle to travel autonomously. The sensor 301 may also include a camera provided on the vehicle 300. For example, the sensor 301 can include an image capturing device using an image sensor such as charged-coupled devices (CCD), a metal-oxide-semiconductor (MOS), or a complementary metal-oxide-semiconductor (CMOS).

The location information acquisition unit 302 is a unit configured to acquire the current location of the vehicle 300, and typically includes a GPS receiver or the like. The information acquired by the location information acquisition unit 302 is transmitted to the control unit 303.

The control unit 303 is a computer that controls the vehicle 300 based on information acquired from the sensor 301. The control unit 303 may be configured by a microcomputer, for example.

The control unit 303 includes an environment detection unit 3031 and a task control unit 3032 as functional modules. Each functional module may be implemented by executing a program stored in a storage device (such as ROM) by the CPU.

The environment detection unit 3031 detects the environment around the vehicle based on the data acquired by the sensor 301. Detection targets include, for example, but are not limited to, the number and positions of lanes, the number and positions of vehicles existing around the host vehicle, the number and positions of obstacles (for example, pedestrians, bicycles, structures, buildings) existing around the host vehicle, road structures, and road signs. Any detection target may be used as long as it is necessary for autonomous traveling. Further, the environment detection unit 3031 may track the detected object. Data relating to the environment (hereinafter referred to as “environment data”) detected by the environment detection unit 3031 is transmitted to the task control unit 3032.

The task control unit 3032 executes the designated task based on the service command. For example, in a case where the task is traveling to the designated point, the task control unit 3032 controls traveling of the host vehicle, based on the service command received from the server device 100, the environment data generated by environment detection unit 3031, and the location information of the host vehicle acquired by the location information acquisition unit 302. For example, the host vehicle may be directed to travel along a predetermined route such that the obstacle does not enter a predetermined safety area centered on the host vehicle. A well-known method can be adopted as a method for allowing the vehicle to autonomously travel. The travel route may be, for example, automatically generated based on a given departure point and destination with reference to map data previously stored. Alternatively, it may be generated using an external service.

The task control unit 3032 also executes a predetermined task on the route and at the destination. Examples of such a task include, but are not limited to, “loading the service unit 200”, “cooperating with the service unit 200 to allow passengers to board/alight and load/unload cargo” and “notifying the user that the vehicle will arrive soon”.

The drive unit 304 is a unit that drives the vehicle 300. The drive unit 304 is configured to include, for example, a motor for driving wheels, an inverter, a brake, a steering mechanism, and a secondary battery. The communication unit 305 is a communication unit configured to allow the vehicle 300 to access the network. In the present embodiment, the vehicle can communicate with the server device 100 or the service unit 200 via the network using a mobile communication service such as 4G, LTE, or 5G. Further, the communication unit 305 may further include a communication unit for inter-vehicle communication with other vehicles.

The vehicle 300 is configured to be capable of loading the service units 200. Further, the vehicle 300 is provided with a mechanism (elevator, actuator, guide rail or the like) for loading and unloading only a predetermined service unit 200 from among the service units 200. These components are controlled by the task control unit 3032.

The service unit 200 and the vehicle 300 periodically notify the server device 100 of their own status during the provision of the service. The server device 100 (management unit 1031) updates the vehicle data 102A and the service unit data 102B based on the notified information. The following is an example of the information transmitted.

Vehicle 300

Location information
Sizes, weights, number of service units that can be loaded
Identifier of the service unit currently coupled with the vehicle
Current battery level (SOC)
Maximum driving range
Information on operation routes (when the vehicle is in operation)

Service Unit 200

Location information
Vehicles that can be coupled with the service unit
Identifier of the vehicle currently coupled with the service unit
Current battery level (SOC)
Subject to be transported and capacity

Next, a process executed by the server device 100 will be described with a specific example. FIG. 8 shows an example of the demand data acquired by the server device 100. The demand data is data indicating when the passenger and/or cargo should be transported from a location to a location. The demand data is generated, for example, based on the information transmitted from a portable terminal owned by the user. For example, the portable terminal owned by the user acquires information on whether there is demand for passengers and/or cargo to be transported, together with information on the number of persons or the amount of cargo, and transmits an operation request to the server device 100. The server device 100 adds up the operation requests received during a predetermined period and generates the demand data. Additionally, in a case where users desire to board and alight at different points, adjacent points may be combined into a single point.

The server device 100 determines the vehicle 300 to be dispatched, and the types and numbers of the service units 200 to be loaded into the vehicle 300, based on the demand data corresponding to the predetermined period. For example, the server device 100 generates a model of passengers and cargo traveling on a space-time network, and searches for a combination of the service units 200 that can minimize the transportation cost. Further, the number of the vehicles 300 for transporting the service units 200 is determined. A specific example will be described later. The server device 100 processes the demand data to determine the number of the vehicles 300 and the types and numbers of the service units 200 required to meet the transportation demand represented by the demand data.

Next, the server device 100 determines a travel route of the vehicle 300 and a process to be executed on the route for each vehicle 300. For example, it is determined at which service base the service unit 200 will be loaded, or at which point the passengers will board/alight or cargo will be loaded/unloaded. Consequently, the transportation schedule as shown in FIG. 6 is generated. Finally, the server device 100 generates the service command for one or more vehicles 300 based on the generated transportation schedule, and transmits the command to each vehicle 300.

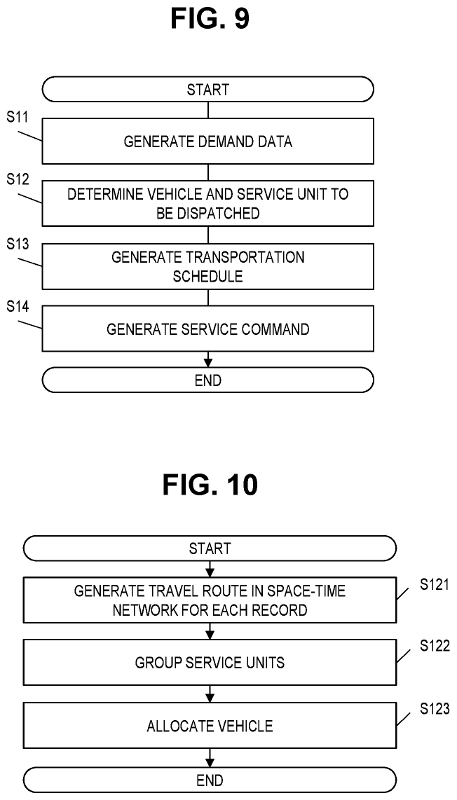

Next, the process stated above will be described in more detail referring to a flowchart. FIG. 9 is a flowchart of a process in which the server device 100 generates the service command based on the operation request.

When several user terminals transmit operation requests to the server device 100, the server device 100 (transportation schedule generation unit 1032) receives those operation requests. Each of the service requests includes data relating to a transportation target (whether passengers or cargo), the number of passengers, the amount of cargo, boarding and alighting points, and loading and unloading points. The transportation schedule generation unit 1032 generates the demand data based on the operation requests received within the predetermined period (step S11). In the present embodiment, the server device 100 generates the demand data based on the operation requests, but the demand data may be generated by an external device and acquired by the server device 100.

In step S12, the transportation schedule generation unit 1032 determines the vehicle 300 and the service unit 200 to be dispatched based on the demand data, for example, as described above. FIG. 10 is a flowchart illustrating details of the process executed in step S12. In step S121, a travel route in the space-time network is generated for each record of the demand data. The service unit 200 is allocated to each record. The service unit may be allocated by extracting the service unit 200 that can offer the require services from among the service units recorded in the service unit data.

Next, the service units are grouped in step S122. This process is a process of compiling the service units transported by the same vehicle 300. For example, in a case where there are two or more service units that are close to each other on the space-time network and that can be transported at the same time, those service units are grouped. For example, in a case where a travel route of a passenger unit P1 and a travel route of a cargo unit K1 are similar to each other, those service units are grouped. The service units belonging to the same group are transported by the same vehicle 300. The service units are grouped within the limits of the capacity of the vehicle 300. In a case where the capacity of the vehicle 300 is not sufficient or the travel routes of two or more service units are not similar, different vehicles 300 are allocated.

Two or more service units grouped together may be further replaced with a single service unit. For example, a passenger unit having a capacity of 4 persons and a passenger unit having a capacity of 2 persons may be grouped and replaced with a passenger unit having a capacity of 6 persons. Next, the vehicles 300 are allocated to the service units grouped in step S123. The vehicle may be allocated by extracting the vehicle 300 that can offer the require services from among the vehicles 300 recorded in the vehicle data.

Consequently, a combination of one or more vehicles 300 to be dispatched and the service units 200 to be loaded on the vehicles 300 is determined. The service unit 200 and the vehicle 300 to be dispatched may be determined by a method other than the exemplified method.

The description will be continued returning to FIG. 9. In step S13, the transportation schedule generation unit 1032 generates a transportation schedule based on which the determined vehicle 300 travels. The transportation schedule may include, for example, a travel route of the vehicle 300, a service base at which the service unit 200 is loaded, an identifier of the loaded service unit 200, and boarding/alighting points of passengers and loading/unloading points of cargo.

In step S14, the service command unit 1033 generates a service command that defines a task executed by the vehicle 300 based on the generated transportation schedule, and transmits the service command to the vehicle 300.

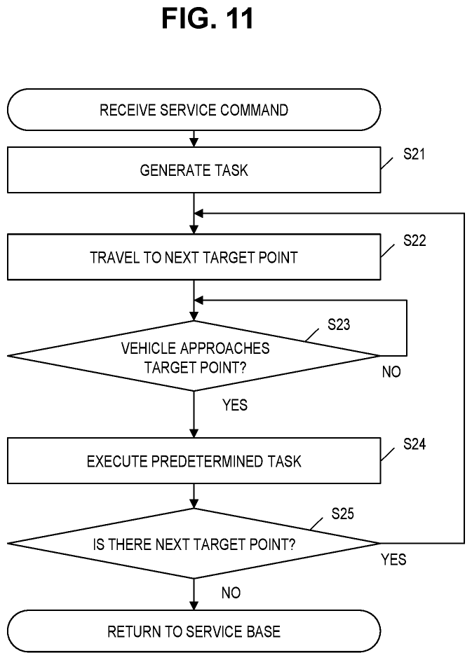

FIG. 11 is a flowchart of a process executed by the vehicle 300 that receives the service command. In step S21, the vehicle 300 (task control unit 3032) generates a task based ono the received service command. For example, a task of loading the required service unit 200 at a predetermined service base, a task of loading/unloading cargo and allowing passengers to board/alight at a designated point, and a task of returning to the service base are generated.

In step S22, the task control unit 3032 allows the vehicle to travel toward a target point based on the generated task. Even during the service, status information is periodically transmitted to the server device 100.

When the vehicle approaches the target point (step S23), the task control unit 3032 searches for a place at which the vehicle can be stopped in the vicinity, stops the vehicle, and executes a predetermined task (step S24). Examples of the predetermined tasks include loading the service unit 200, allowing the passengers to board/alight, the cargo to load/unload, and calling a user, but there may be other tasks. Further, the task may be executed in cooperation with the control unit 202.

Next, the task control unit 3032 determines whether there is a next target point based on the generated task (step S25), and in a case where there is a next target point, the vehicle continues to travel. In a case where there is no next target point, the vehicle returns to the service base.

As described above, according to the present embodiment, the combination of the passenger unit and the cargo unit to be loaded on the vehicle 300 is dynamically determined based on the demand data. Accordingly, it is possible to meet both demands for transporting passengers and demands for transporting cargo with minimum vehicle resources.

### MODIFIED EXAMPLE

The embodiments stated above are mere examples, and the present disclosure can be implemented with appropriate modifications within a scope not departing from the gist thereof. For example, the processing and units described in the present disclosure can be freely combined and implemented unless technical contradiction occurs.

Further, in the description of the embodiment, the types and the numbers of service units 200 to be loaded into the vehicle 300 are determined. However, in a case where the vehicle 300 has sufficient space, an optional unit not directly related to the transportation of passenger and/or cargo may be loaded in order to use the space.

Further, in the description of the embodiments, the demand data is data representing the actual demand, but the demand data may be data for forecasting the demand. For example, the external device may generate data for forecasting future demand based on performance history. In this case, the server device 100 may issue a command (for example, a command to load a predetermined passenger unit and a predetermined cargo unit) to the vehicle 300 in advance, in order to assemble a required vehicle before the demand actually exists.

Although the vehicle 300 is illustrated in the description of the embodiment, the transportation system according to the embodiment may be applied to vehicles other than automobiles. For example, it is possible to build an aircraft or a ship used for transportation by loading a service unit on an aircraft platform (e.g. drone) or a ship platform.

Further, the process described as being performed by a single device may be executed in a shared manner by a plurality of devices. Alternatively, the process described as being performed by a plurality of devices may be executed by a single device. In the computer system, the hardware configuration (server configuration) for implementing each function can be flexibly changed.

The present disclosure can also be implemented by supplying a computer program executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include random disk (such as a magnetic disk (floppy (registered trademark) disk, hard disk drive (HDD), and the like) or optical disc (CD-ROM, DVD disc, Blu-ray disc, and the like)), read-only memory (ROM), random access memory (RAM), EPROM, EEPROM, magnetic card, flash memory, optical card, and random type of medium suitable for storing electronic instructions.

What is claimed is:

1. An information processing apparatus, which manages a vehicle platform configured to be loaded with a plurality of vehicle compartment units, a first vehicle compartment unit configured to transport a passenger and a second vehicle compartment unit configured to transport cargo, the first and second vehicle compartment units configured to be loaded on the vehicle platform, the information processing apparatus comprising:
a control unit configured to:
acquire first demand data representing demand associated with transportation of the passenger and second demand data representing demand associated with transportation of the cargo in a predetermined period; and
determine a combination of one or more first vehicle compartment units and one or more second vehicle compartment units, which are loaded on a predetermined vehicle platform, based on the first demand data and the second demand data.

2. The information processing apparatus according to claim 1, wherein:
the first demand data includes the number of passengers to be transported; and
the control unit is configured to determine the number or sizes of the first vehicle compartment units to be loaded on the vehicle platform according to the number of passengers.

3. The information processing apparatus according to claim 2, wherein:
the second demand data includes an amount of cargo to be transported; and
the control unit is configured to determine the number or sizes of the second vehicle compartment units to be loaded on the vehicle platform according to the amount of cargo.

4. The information processing apparatus according to claim 2, wherein the control unit is configured to periodically acquire information indicating locations of the first vehicle compartment unit and the second vehicle compartment unit.

5. The information processing apparatus according to claim 4, wherein the control unit is configured to determine a base where at least one of the determined first and second vehicle compartment units is providable.

6. The information processing apparatus according to claim 5, wherein the control unit is configured to determine an operation route of the vehicle platform that passes through the determined base.

7. The information processing apparatus according to claim 6, wherein the control unit is configured to determine the operation route of the vehicle platform that passes through a point designated by the first demand data and the second demand data.

8. The information processing apparatus according to claim 7, wherein the control unit is configured to determine a command to cause the vehicle platform to operate along the determined operation route.

9. The information processing apparatus according to claim 8, wherein the command includes a command to load at least one of the determined first and second vehicle compartment units on the vehicle platform at the determined base

10. The information processing apparatus according to claim 9, wherein the command includes a command to allow the passenger to board or alight, or to load or unload the cargo at the designated point.

11. An information processing method executed by an information processing apparatus which manages a vehicle platform configured to be loaded with a plurality of vehicle compartment units, a first vehicle compartment unit configured to transport a passenger and a second vehicle compartment unit configured to transport cargo, the first and second vehicle compartment units configured to be loaded on the vehicle platform, the information processing method comprising:
acquiring first demand data representing demand associated with transportation of the passenger and second demand data representing demand associated with transportation of the cargo in a predetermined period; and
determining a combination of one or more first vehicle compartment units and one or more second vehicle compartment units, which are loaded on a predetermined vehicle platform, based on the first demand data and the second demand data.

12. The information processing method according to claim 11, wherein the first demand data includes the number of passengers to be transported, and further comprising determining the number or sizes of the first vehicle compartment units to be loaded on the vehicle platform according to the number of passengers.

13. The information processing method according to claim 12, wherein the second demand data includes an amount of cargo to be transported, and further comprising determining the number or sizes of the second vehicle compartment units to be loaded on the vehicle platform according to the amount of cargo.

14. The information processing method according to claim 12, further comprising periodically acquiring information indicating locations of the first vehicle compartment unit and the second vehicle compartment unit.

15. The information processing method according to claim 14, further comprising determining a base where at least one of the determined first and second vehicle compartment units is providable.

16. The information processing method according to claim 15, further comprising determining an operation route of the vehicle platform that passes through the determined base.

17. The information processing method according to claim 16, further comprising determining the operation route of the vehicle platform that passes through a point designated by the first demand data and the second demand data.

18. The information processing method according to claim 16, further comprising determining a command to cause the vehicle platform to operate along the determined operation route.

19. The information processing method according to claim 18, wherein the command includes a command to load at least one of the determined first and second vehicle compartment units on the vehicle platform at the determined base.

20. A program causing a computer to execute the information processing method according to claim 11.
